(19) United States
(12) Patent Application Publication
(10) Pub. No.: US 2024/0311118 A1
(43) Pub. Date: Sep. 19, 2024

(54) AI BASED OPERATOR INSTALL ADVISOR

(71) Applicant: INTERNATIONAL BUSINESS MACHINES CORPORATION, ARMONK, NY (US)

(72) Inventors: Abhishek Malvankar, White Plains, NY (US); John M. Ganci Jr., JR., Raleigh, NC (US); Brent Wolfe, Fayetteville, NY (US); Carlos A. Fonseca, LaGrangeville, NY (US); Abdoulaye K. Traore, Yonkers, NY (US)

(21) Appl. No.: 18/183,127

(22) Filed: Mar. 13, 2023

(51) Int. Cl. G06F 8/61; G06N 20/00

(52) U.S. Cl. CPC G06F 8/61; G06N 20/00

(57) ABSTRACT

A computer-implemented method of determining installation compatibility includes identifying one or more entities of an uninstalled operator. The identified one or more entities of the uninstalled operator are parsed and information is extracted from the one or more entities. An existing operator installed on a target container cluster is parsed and information extracted from the entities of the existing operator. The extracted information from the uninstalled operator is compared with the extracted information from the existing operator. A disruption risk to operation of the target container cluster is ranked based on the comparing of the extracted information of the uninstalled operator with the extracted information of the existing operation.

### BACKGROUND

### Technical Field

The present disclosure generally relates to risk analysis for the installation and/or upgrade of multiple applications on cluster frameworks. More particularly, the present disclosure relates to risk analysis for a container environment.

### Description of the Related Art

In extensible frameworks such as Kubernetes, functions for custom scheduling, autoscaling, and adhering to management policies may be performed by the use of operators. An Operator is a method of packaging, deploying and managing a Kubernetes-native application. The installation of operators on a Kubernetes application may cause performance issues or failures in an entire Kubernetes cluster, typically resulting in a roll-back of operator components. Such roll-backs leave remnants of the operator may result in manual detection and cleanup.

### SUMMARY

According to one embodiment, a computer-implemented compatibility method includes identifying one or more entities of an uninstalled operator. The identified one or more entities of the uninstalled operator are parsed and information is extracted from the one or more entities. An existing operator installed on a target container cluster is parsed and information extracted from the entities of the existing operator. The extracted information from the uninstalled operator is compared with the extracted information from the existing operator. A disruption risk to operation of the target container cluster is ranked according to a scale based on the comparing of the extracted information of the uninstalled operator with the extracted information of the existing operation.

In one embodiment, an install risk score is provided for installation of the uninstalled operator on the target container cluster.

In one embodiment, the parsing of entities of an existing operator installed on a target container cluster includes querying a current cluster state of an environment of the target container, and performing analysis of at least one existing service, a service account, a role binding and/or a cluster binding.

In one embodiment, an Artificial Intelligence (AI) advisor is configured to use Natural Language Processing (NLP) to identify the one or more entities of the uninstalled operator.

In one embodiment, the NLP parses the extracted information of the one or more entities into sections.

In one embodiment, the sections include one or more of supported features, documentation, prerequisites, operator compatibility level, and a date of publication of the uninstalled operator.

In one embodiment, the identifying of the one or more entities of the uninstalled operator is performed by a Natural Language Processing (NLP) model.

In one embodiment, the NLP model is trained to extract information of the one or more entities from a data source.

In one embodiment, the NLP model is trained to extract information the one or more entities from an OperatorHub data source.

In one embodiment, the training of the NLP model includes training a classifier on a custom data set to provide classification over each comparison of the extracted information from the uninstalled operator with the extracted information from the existing operator.

In one embodiment, the ranking of the disruption risk is performed for operation of a Kubernetes target container cluster.

In one embodiment, the ranking of the disruption risk is performed for operation of an Openshift target container cluster.

According to one embodiment, a computer program product includes one or more computer-readable storage devices and program instructions stored on at least one of the one or more computer-readable storage devices, the program instructions executable by a processor. The program instructions cause the processor to perform acts including identifying one or more entities of an uninstalled operator. The identified one or more entities of the uninstalled operator are parsed and information extracted from the one or more entities. The entities of an existing operator installed on a target container cluster are parsed and information extracted information from the entities of the existing operator. The extracted information from the uninstalled operator is compared with the extracted information from the existing operator. A disruption risk to operation of the target container cluster is ranked based on the comparing of the extracted information of the uninstalled operator with the extracted information of the existing operation.

According to one embodiment, a computer-implemented compatibility method includes detecting a selection on a display of an advisor button configured for a risk score analysis of an uninstalled operator on a target container cluster. An analysis of the uninstalled operator is performed including querying a current cluster state of the target container cluster, a comparison of the uninstalled operator to current container environmental variables, and an assessment of a potential outcome of an installation of the uninstalled operator with an aggregated risk assessment. An install option is provided on the display to proceed with the installation of the uninstalled operator in response to determining assessment of the potential outcome is successful based on the aggregated risk assessment.

In one embodiment, the aggregated risk assessment includes a numerical score or a descriptive term, and providing the install option includes displaying a visual indication of the numerical score or descriptive term associated with the aggregated risk assessment.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 illustrates an architectural overview of the AI based operator install advisor, consistent with an illustrative embodiment.

FIG. 2 illustrates an enhancement attributed to the AI based operator install advisor, consistent with an illustrative embodiment.

FIG. 3 illustrates a display of a risk assessment output regarding the potential installation of an operator to a target container cluster, consistent with an illustrative embodiment.

FIG. 4 is a flowchart illustrating operations for a computer-implemented method of an AI based operator install advisor, consistent with an illustrative embodiment.

FIG. 5 is a flowchart illustrating operations for a computer-implemented method of an AI based operator install advisor, consistent with an illustrative embodiment.

FIG. 6 illustrates a block diagram of a computing environment in accordance with an illustrative embodiment.

### DETAILED DESCRIPTION

In the following detailed description, numerous specific details are set forth by way of examples to provide a thorough understanding of the relevant teachings. However, it is to be understood that the present teachings may be practiced without such details. In other instances, well-known methods, procedures, components, and/or circuitry have been described at a relatively high-level, without detail, to avoid unnecessarily obscuring aspects of the present teachings. It is also to be understood that the present disclosure is not limited to the depictions in the drawings, as there may be fewer elements or more elements than shown and described.

As used herein, the terms “coupled” and/or “electrically coupled” are not meant to mean that the elements must be directly coupled together-intervening elements may be provided between the “coupled” or “electrically coupled” elements. In contrast, if an element is referred to as being “directly connected” or “directly coupled” to another element, there are no intervening elements present. The term “electrically connected” refers to a low-ohmic electric connection between the elements electrically connected together.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

As used herein, an “operator” is a method of packaging, deploying and managing a Kubernetes-native application.

As used herein, the term “outlined” is defined as the metadata or URL links is present inside an operator hub portal.

As used herein, “OperatorHub” refers to a web console interface in an OpenShift Container Platform that is used for the discovery and installation of Operators. An operator is obtained from an off-cluster source, installed and subscribed on the cluster using Operator Hub.

As used herein, “Seldon Core” is an open-source framework for machine-learning model deployment and monitoring at scale on a Kubernetes cluster. Seldon Core allows for machine learning practitioners to convert machine learning model code or trained model artifacts into full-fledged microservices. “Seldon Operator” enables native operation of the production of machine learning workloads, including the monitoring and operations of language agnostic models with the benefits of real time metrics and log analysis.

As used herein, “compatibility” refers to software components which can operate satisfactorily (without failure or degradation) together on a same computer, a computing cluster, or on different computers linked by a network.

It is to be understood that other embodiments may be used and structural or logical changes may be made without departing from the spirit and scope defined by the claims. The description of the embodiments is not limiting. In particular, elements of the embodiments described hereinafter may be combined with elements of different embodiments.

### Overview

The present disclosure provides a computer-implemented method and computer device for an adviser-based tool that provides an analysis regarding the successful implementation of an operator and the impact of the operator on a target container environment, including but not limited to Openshift or Kubernetes. In one or more embodiments, the analysis is score-based.

Operators can be installed by users that may involve admin privileges. Some operators can perform a variety of functions including but not limited to upgrading a host operating system, upgrading deployed software components, and scaling deployed software components. Operators have different levels of maturity and certifications in Kubernetes ecosystems for performing install/upgrade tasks.

While operations are efficient at managing a single deployed application, they typically cannot perform the discovery of cluster wide resources. Operators cannot perform the discovery of other operators requiring specific cluster wide resources. A cluster wide dependency of an operator can alter that dependency and render an entire Kubernetes/Openshift cluster inoperative. However, the task of verifying the compatibility of an operator is reactive rather than proactive. Accordingly, installing and/or upgrading operators puts active workloads running a cluster at risk.

In the present disclosure, Natural Language Processing (NLP) is applied to discover entities from OperatorHub and provide a classification mechanism on existing components already installed to provide a risk score-based analysis on the probability of a successful implementation of the operator and the impact to the target container environment. The computer-implemented method and device according to the present disclosure provides an improvement in the reliability of computer operations in the field of cluster operations in a container environment, and an improvement in the installation and upgrade of operators to be applied to computer systems in a proactive manner rather than a reactive manner. The risk-based score may be used to determine whether or not to proceed in the installation or upgrade of operator to the target container, or to possibly defer the installation and/or upgrade to a time when there are no active workloads in operation. If the risk is severe, the installation or upgrade of the operators may not occur.

### Example Architecture

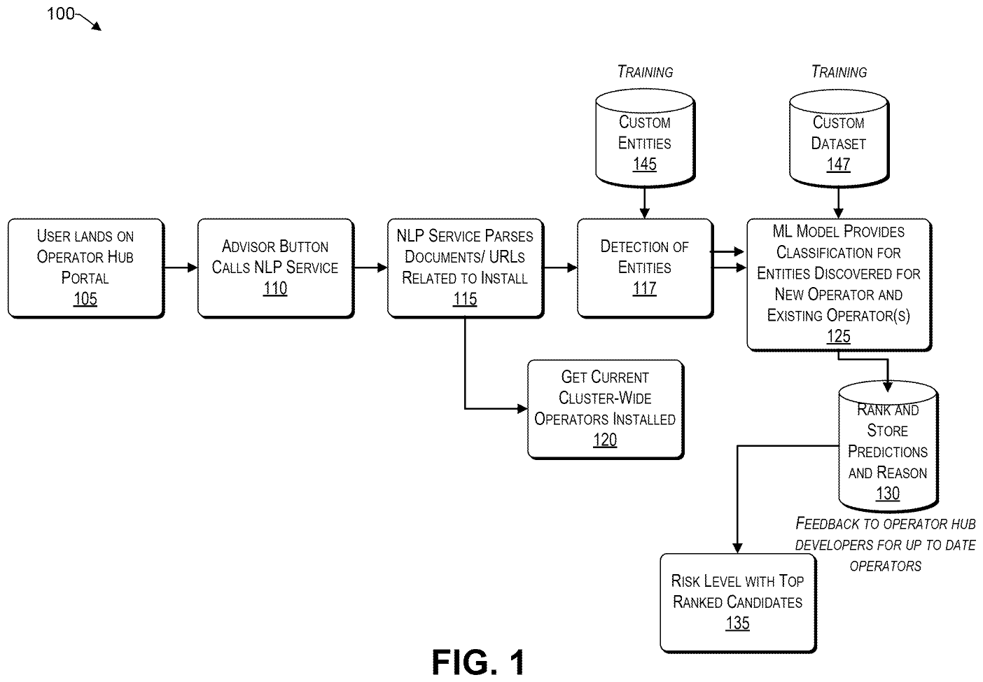

FIG. 1 illustrates an architectural overview of the AI based operator install advisor, consistent with an illustrative embodiment. It is to be understood that FIG. 1 is provided for illustrative purposes and the teachings of the present disclosure are not limited to the overview shown and described herein.

To assess the possible risk associated with installation of an operator on a targeted container cluster, there is a user interface screen showing an Operator hub portal 105 (e.g., a call button). The hub portal is selected, and an advisor button 110 calls a Natural Language Processor (NLP) service. The NLP service 115 parses documents/URLs related to a potential operator install. The parsing process includes determining all of the cluster-wide operators current installed 120 on a target container cluster (e.g., a Kubernetes or Openshift cluster). The operator install advisor includes a model that is trained and updated by a machine language (ML) training model 125 (in which custom entities 145 and a custom dataset 147 are used to train the ML model 125. The documents/URLs related to the install are parsed by NLP service 115 and a detection of entities 117 of the parsed output from the NLP service 125 is performed, based on training of the custom entities 145. The ML model 125 provides classification for entities discovered for a new to-be-installed operator and existing operators.

There are a rank and store predictions 130 provided along with reasons for the prediction assessment. There may also be feedback provided to operator hub developers that can aid in an investigation of the potential risk that the to-be-installed operator may cause to a target container cluster. A risk level with top ranked candidates 135 may be provided to the operator. The risk may be further simplified with categories such as low, medium, and high-risk so that at a glance a user can consider whether to proceed with an operator installation to the target container cluster.

In an embodiment, there is ranking layer that takes multiple target scores as input. Based on user preference, the ranking layer may have a combination of listwise and pairwise ranking. Listwise ranking takes ranked lists of objects as instances to train a ranking function through the minimization of a listwise loss function. Pairwise ranking takes object pairs as instances in learning. Pairwise is performed for all the entities in the same class. Listwise ranking is performed for all the entities on the across (e.g., traverse) class. The combination of pairwise and listwise ranking facilitates top-K classification (operator names) that is disrupted when the next operator is installed.

With further regard to the ML training, existing cluster wide installed operator information can be obtained by issuing a “REST API” call to the cluster. Some examples of metadata extraction may include “oc get packagemanifests-n openshift-marketplace” operation and additional entities are obtained from OperatorHub. Some of the example entities include Operator certification type, Operator maturity level, Date last updated, Operator installed age, and Operator workload execution. These custom entities may be used to train entity extraction system.

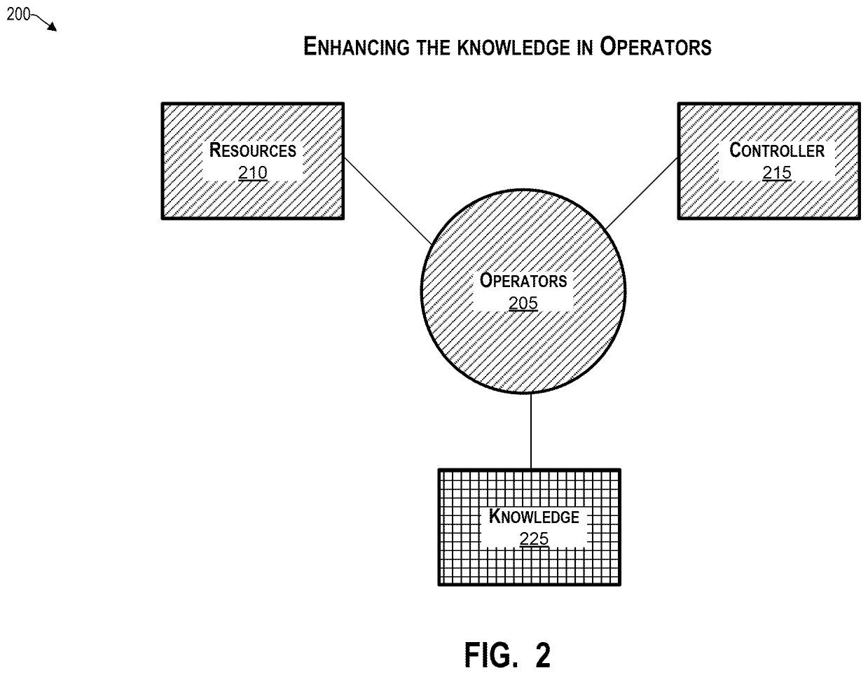

FIG. 2 illustrates an enhancement attributed to the AI based operator install advisor, consistent with an illustrative embodiment. In a typical cluster environment, there may be operators 205, resources 210 and a controller 215 that controls the various operators. In the present disclosure, the install advisor provides additional knowledge 225 regarding the operators and the risk that interaction of a new to-be-installed operator may have on a target container cluster. The risk assessment provided (e.g., knowledge 225) can pre-empt the application, and then “backing off” of an operator installation, and prevent adverse system operation or downtime of the target container cluster and operations dependent on the target container cluster.

### Example Embodiments

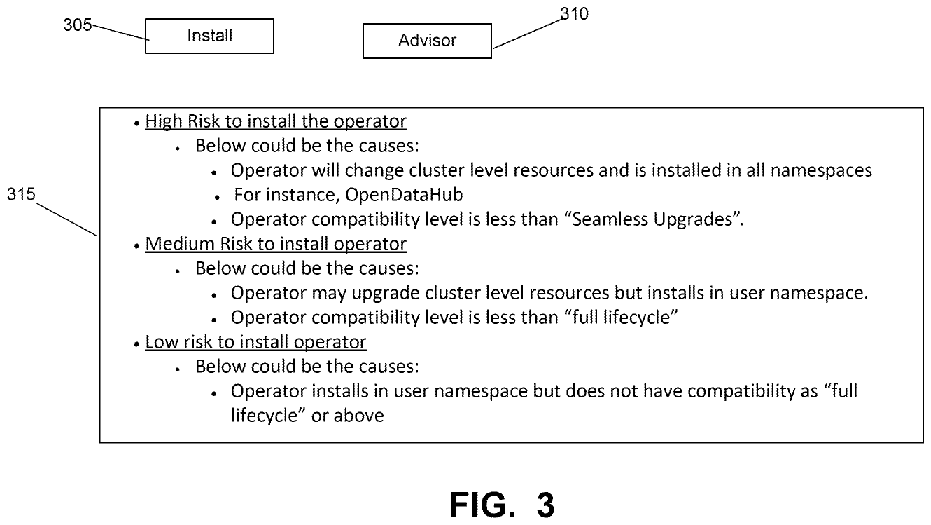

FIG. 3 illustrates a display of a risk assessment output regarding the potential installation of an operator to a target container cluster, consistent with an illustrative embodiment. In FIG. 3, a screen shows an install button 305 for an operator. In addition, there is an “Advisor” button 310 according to the present disclosure. The Advisor button 310, when selected, is operative to start the operation of determining a risk associated with installation of an operator on a target container cluster.

By way of example only and not by way of limitation, box 315 shows three possible categories of display regarding the risk (e.g., low, medium and high). For example, in the case of a high-risk to install the operator, causes could be that the operator application changes cluster level resources and is installed in all namespaces. For example, OpenDataHub is used to change the cluster level resources. In addition, the operator compatibility level may be less than “Seamless Upgrades” under the high-risk category.

For example, a medium risk to install the operator may be caused from the operator may upgrade cluster level resources but installs the operator in the user namespace. An operator compatibility level may be less than “full lifecycle.” Thus, causing a medium risk to be determined by ML model 125.

In the case of a low risk to install operator, the cause may be that the Operator installs in the user namespace but does not have compatibility as “full lifecycle” or above.

### Example Process

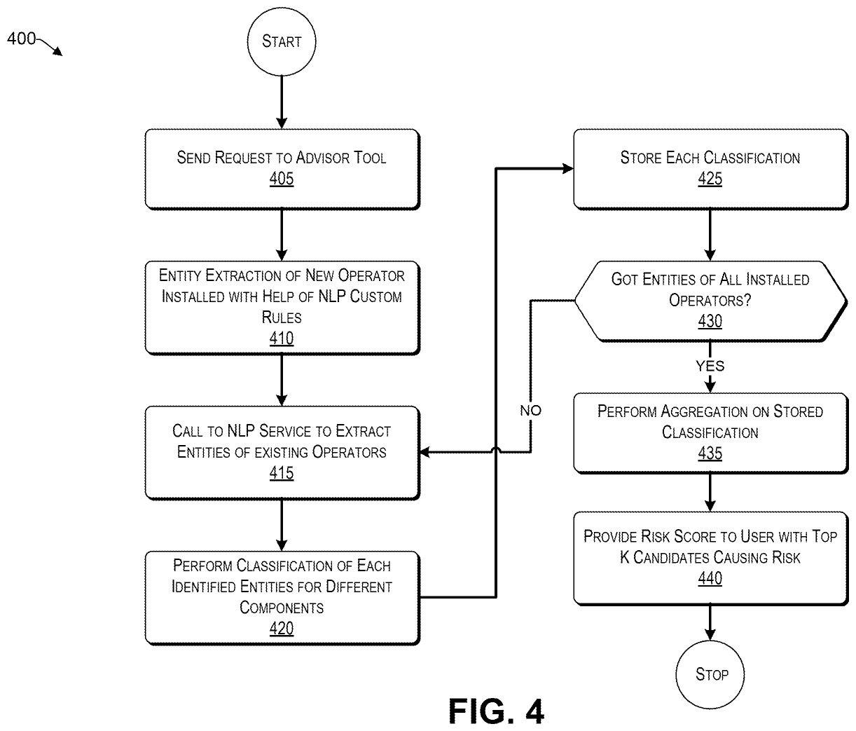

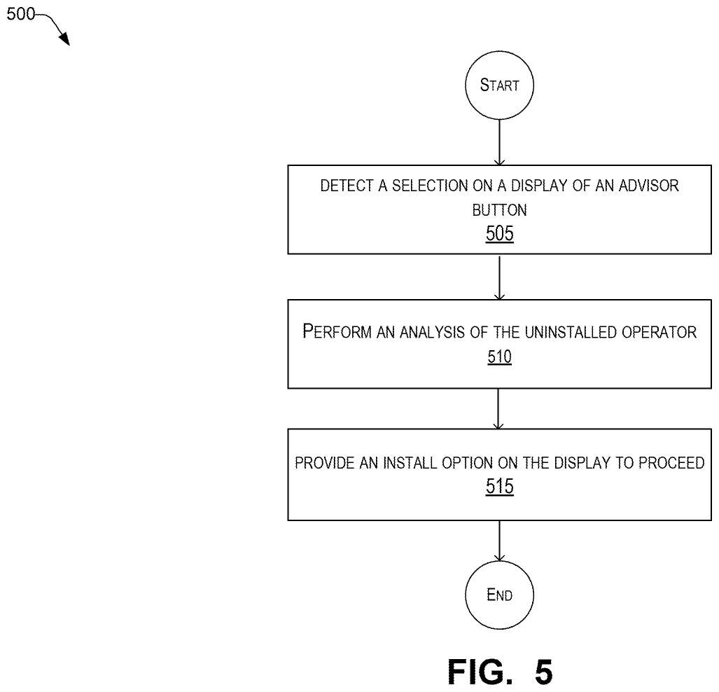

With the foregoing overview of the example architecture, it may be helpful now to consider a high-level discussion of an example process. To that end, FIGS. 4 and 5 are flowcharts illustrating operations for a computer-implemented method of an AI based operator install advisor, consistent with an illustrative embodiment. FIG. 4 is a flowchart illustrating operations for a computer-implemented method of an AI based operator install advisor, consistent with an illustrative embodiment.

FIG. 4 is a flowchart 400 illustrating some of the operations for a method of AI based operator install advisor, consistent with an illustrative embodiment. It is to be understood that the process shown and described is provided for illustrative purposes.

FIG. 4 is shown as a collection of blocks, in a logical order, which represents a sequence of operations that can be implemented in a combination thereof.

At operation 405, a request for risk assessment regarding a to-be-installed operator is sent to the advisor tool. There can be a selection button on a display screen such as shown in FIG. 3.

At operation 410, entity extraction of the new operator can be performed with the help of NLP custom rules. FIG. 1 shows there are custom entities and a custom dataset used as training data to perform these tasks. In one non-limiting example, an entity extraction system extracts entities from a new software component that is to be installed, from data sources such as OperatorHub, and Github repositories that are outlined.

At operation 415 the NLP service extracts entities of existing operators. In one non-limiting example, the entity extraction system extracts existing software components that are installed cluster wide, from data sources such as OperatorHub, and Github repositories that are outlined.

At operation 420, classification of each of the identified entities is performed for different components. A machine learning model provides classification for the entities discovered for the to-be-installed operator and for the existing operators in, or dependent on, the target container cluster.

At operation 425, each classification is stored. As previously discussed, a listwise classification and a pairwise classification may be performed.

At operation 430, the computing device determines whether all of the installed operators have had their entities extracted. If yes, then an aggregation is performed on the stored classification (operation 435). If no, then another call to NLP service at operation 415 is performed to extract entities of the existing operators.

At operation 440, the risk score is provided to the user with top K candidates causing the risk. Thus, the user can receive a numerical score (e.g., 75 out of 100, 4 out of 5, etc.), or a range score (e.g., low, medium, high) with the potential causes of the risk. As discussed with regard to FIGS. 1 and 3, the combination of pairwise and listwise ranking helps top-K classification (operator names) that are disrupted when the next operator is installed. The method ends after operation 440.

FIG. 5 is a flowchart illustrating operations 500 for a computer-implemented method of an AI based operator install advisor, consistent with an illustrative embodiment.

At operation 505, a selection is detected on a display of an advisor button. The advisor button is configured for a risk score analysis of an uninstalled operator on a target container cluster. The advisor button may, in a non-limiting example, appear as the advisor button 310 in FIG. 3.

At operation 510, an analysis is performed of the uninstalled operator. This analysis includes querying a current cluster state of the target container cluster, comparing he uninstalled operator to current container environmental variables of installed operators, and an assessing a potential outcome of an installation of the uninstalled operator with an aggregated risk assessment.

At operation 515, an install option is provided on the display to permit selection to proceed with the installation of the uninstalled operator in response to determining assessment of the potential outcome is successful based on the aggregated risk assessment. In this embodiment, a risk score, a potential degradation, or failures of existing operators may be displayed to assist in providing knowledge that can be used to address the risk ranking issues, prior to installing the operator.

### Example Data Processing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

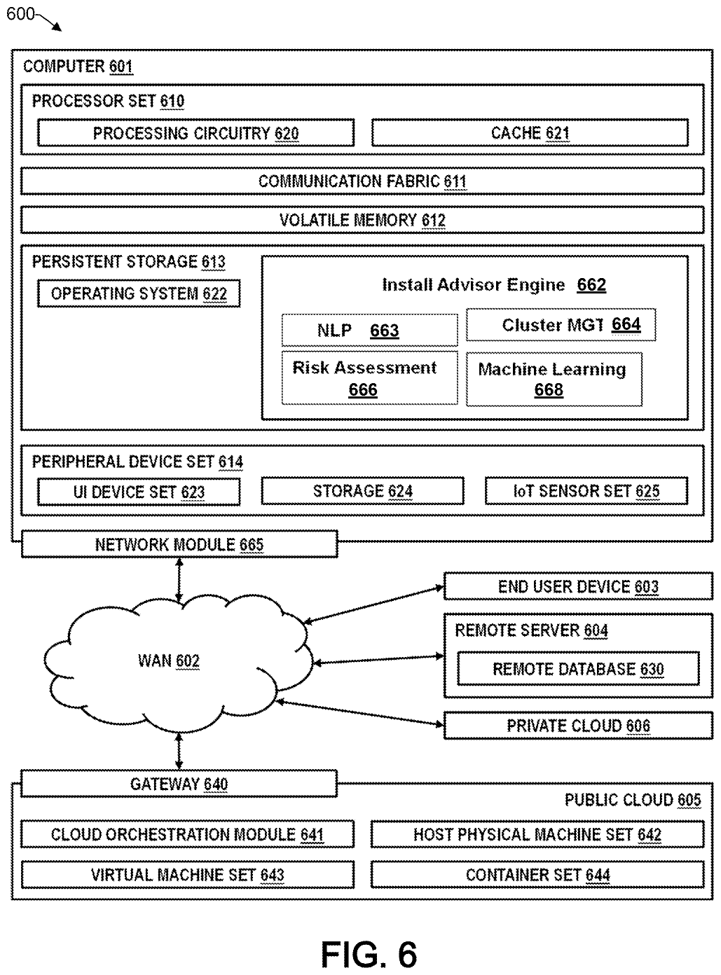

With reference to FIG. 6, computing environment 600 includes an example of an environment for the execution of at least some of the computer code involved in performing the inventive methods, such as install advisor engine 662. A Natural Language Processing Module (NLP) 663, a cluster management module 664, a risk assessment module 666, and a machine learning module 668 for training the install advisor engine 662, are at least some of the elements of the present disclosure. In addition to computing environment 200 includes, for example, Computer 601, wide area network 602 (WAN), end user device 603 (EUD), remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and Install Advisor Engine 662, as identified above), peripheral device set 614 (including user interface (UI) device set 623, storage 624, and Internet of Things (IoT) sensor set 625), and network module 665. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically Computer 601, to keep the presentation as simple as possible. Computer 601 may be located in a cloud, even though it is not shown in a cloud in FIG. 6. On the other hand, Computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto Computer 601 to cause a series of operational steps to be performed by processor set 610 of Computer 601 and thereby effect a computer-implemented method, such that the instructions thus executed instantiates the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in the install advisor engine 700 in persistent storage 613.

Communication fabric 611 is the signal conduction path that allows the various components of Computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, volatile memory 612 is characterized by random access, but this is not required unless affirmatively indicated. In Computer 601, the volatile memory 612 is located in a single package and is internal to Computer 601, but, alternatively or additionally, the volatile memory may be distributed over multiple packages and/or located externally with respect to Computer 601.

Persistent storage 613 is any form of non-volatile storage for computers that is now known or to be developed in the future. The non-volatility of this storage means that the stored data is maintained regardless of whether power is being supplied to Computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface-type operating systems that employ a kernel. The code included in the Install Advisor Engine 700 typically includes at least some of the computer code involved in performing the inventive methods.

Peripheral device set 614 includes the set of peripheral devices of Computer 601. Data communication connections between the peripheral devices and the other components of Computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where Computer 601 is required to have a large amount of storage (for example, where Computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 665 is the collection of computer software, hardware, and firmware that allows Computer 601 to communicate with other computers through WAN 602. Network module 665 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 665 are performed on the same physical hardware device. In other embodiments (for example, embodiments that utilize software-defined networking (SDN)), the control functions and the forwarding functions of network module 226 are performed on physically separate devices, such that the control functions manage several different network hardware devices. Computer readable program instructions for performing the inventive methods can typically be downloaded to Computer 601 from an external computer or external storage device through a network adapter card or network interface included in network module 665.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 603 is any computer system that is used and controlled by an end user (for example, a customer of an enterprise that operates Computer 601) and may take any of the forms discussed above in connection with Computer 601. EUD 603 typically receives helpful and useful data from the operations of Computer 601. For example, in a hypothetical case where Computer 601 is designed to provide a recommendation to an end user, this recommendation would typically be communicated from network module 665 of Computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to Computer 601. Remote server 604 may be controlled and used by the same entity that operates Computer 601. Remote server 604 represents the machine(s) that collect and store helpful and useful data for use by other computers, such as Computer 601. For example, in a hypothetical case where Computer 601 is designed and programmed to provide a recommendation based on historical data, then this historical data may be provided to Computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 242 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method of installation and update compatibility, the method comprising:
identifying one or more entities of an uninstalled operator;
parsing the identified one or more entities of the uninstalled operator and extracting information from the one or more entities;
parsing entities of an existing operator installed on a target container cluster and extracting information from the entities of the existing operator;
comparing the extracted information from the uninstalled operator with the extracted information from the existing operator; and
ranking a disruption risk to operation of the target container cluster according to a scale based on the comparing of the extracted information of the uninstalled operator with the extracted information of the existing operation.

2. The computer-implemented method according to claim 1, further comprising providing an install risk score for the target container cluster.

3. The computer-implemented method according to claim 1, wherein the parsing of entities of an existing operator installed on a target container cluster includes querying a current cluster state of an environment of the target container, and performing analysis of at least one existing service, a service account, a role binding, or a cluster binding.

4. The computer-implemented method according to claim 1, further comprising providing an Artificial Intelligence (AI) advisor configured to use Natural Language Processing (NLP) to identify the one or more entities of the uninstalled operator.

5. The computer-implemented method according to claim 4, wherein the NLP parses the extracted information of the one or more entities into sections.

6. The computer-implemented method according to claim 5, wherein the sections include one or more of supported features, a documentation, one or more prerequisites, an operator compatibility level, and a date of publication of the uninstalled operator.

7. The computer-implemented method according to claim 1, wherein the identifying of the one or more entities of the uninstalled operator is performed by a Natural Language Processing (NLP) model.

8. The computer-implemented method according to claim 7, further comprising training the NLP model to extract information of the one or more entities from a data source.

9. The computer-implemented method according to claim 7, further comprising training the NLP model to extract information of the one or more entities from an OperatorHub data source.

10. The computer-implemented method according to claim 9, wherein the training of the NLP model includes training a classifier on a custom data set to provide classification over each comparison of the extracted information from the uninstalled operator with the extracted information from the existing operator.

11. The computer-implemented method according to claim 1, wherein the ranking of the disruption risk is performed for operation of a Kubernetes target container cluster.

12. The computer-implemented method according to claim 1, wherein the ranking of the disruption risk is performed for operation of an Openshift target container cluster.

13. A computer program product comprising:
one or more computer-readable storage devices and program instructions stored on at least one of the one or more computer-readable storage devices, the program instructions executable by a processor, the program instructions comprising:
program instructions to identify one or more entities of an uninstalled operator;
program instructions to parse the identified one or more entities of the uninstalled operator and extracting information from the one or more entities;
program instructions to parse entities of an existing operator installed on a target container cluster and extract information from the entities of the existing operator;
program instructions to compare the extracted information from the uninstalled operator with the extracted information from the existing operator; and
program instructions to rank a disruption risk to operation of the target container cluster based on the comparing of the extracted information of the uninstalled operator with the extracted information of the existing operation.

14. The computer program product according to claim 13, further comprising additional program instructions to perform an additional act comprising providing an install risk score for the target container cluster, wherein the target container cluster comprises a Kubernetes target container cluster or an Openshift target container cluster.

15. The computer program product according to claim 13, further comprising additional program instructions to perform additional acts comprising:
providing an Artificial Intelligence (AI) advisor configured to use Natural Language Processing (NLP) to identify the one or more entities of the uninstalled operator; and
parsing, by the NLP, the extracted information of the one or more entities into sections,
wherein the sections include one or more of supported features, documentation, prerequisites, operator compatibility level, and a date of publication of the uninstalled operator.

16. The computer program product according to claim 13, further comprising a Natural Language Processing (NLP) model trained from a data source to identify the one or more entities of the uninstalled operator.

17. The computer program product according to claim 16, wherein the NLP model is trained to extract information of the one or more entities of the uninstalled operator from an OperatorHub data source.

18. The computer program product according to claim 16, wherein the training of the NLP model includes a classifier trained on a custom data set to provide classification for each comparison of the extracted information from the uninstalled operator with the extracted information from the existing operator.

19. A computer-implemented method of determining installation compatibility, the method comprising:
detecting a selection on a display of an advisor button operative to provide a risk score analysis of an uninstalled operator on a target container cluster;
performing an analysis of the uninstalled operator including querying a current cluster state of the target container cluster, a comparison of the uninstalled operator to current container environmental variables of installed operators, and an assessment of a potential outcome of an installation of the uninstalled operator with an aggregated risk assessment; and
providing an install option on the display to proceed with the installation of the uninstalled operator in response to determining that the assessment of the potential outcome is successful based on the aggregated risk assessment.

20. The computer-implemented method according to claim 19, wherein:
the aggregated risk assessment comprises a numerical score or a descriptive term; and
providing the install option includes displaying a visual indication of the numerical score or descriptive term associated with the aggregated risk assessment.
